(19) United States
(12) Patent Application Publication
(10) Pub. No.: US 2012/0062530 A1
(43) Pub. Date: Mar. 15, 2012

(54) Display Control Method and Display Apparatus Supporting Dual-Source Display

(75) Inventor: Deling Xiao, Xiamen (CN)

(73) Assignee: TPV DISPLAY TECHNOLOGY (XIAMEN) CO., LTD., Xiamen Torch Hi-Tech Industrial Dev Zone (CN)

(21) Appl. No.: 13/232,440

(22) Filed: Sep. 14, 2011

(30) Foreign Application Priority Data
Sep. 15, 2010 (CN) 201010281121.X
Sep. 15, 2010 (CN) 201010281122.4

(51) Int. Cl. G09G 5/00

(52) U.S. Cl. 345/204

(57) ABSTRACT

A display control method includes the steps of: (A) converting a first data signal into a first image signal; (B) converting a second data signal into a second image signal; and (C) under control of a clock signal and according to arrangement of two kinds of polarizing films with orthogonal polarization directions on a display panel, outputting the first image signal to pixel units corresponding to which the display panel is provided with a first one of the two kinds of polarizing films and outputting the second image signal to the pixel units corresponding to which the display panel is provided with a second one of the two kinds of polarizing films, so as to generate an image frame on the display panel that corresponds to the first image signal and the second image signal.

### CROSS-REFERENCE TO RELATED APPLICATION

This application claims priorities of Chinese Application Nos. 201010281121.X and 201010281122.4, both filed on Sep. 15, 2010.

### BACKGROUND OF THE INVENTION

1. Field of the Invention

The invention relates to a display control method and a display apparatus, more particularly to a display control method and a display apparatus supporting display of a dual-source image on a single display apparatus.

2. Description of the Related Art

At present, most display devices operate under a single-source display mode, in which images from a single source are displayed on a single display device at one time. Some display devices support the ability to display images from two or more different sources (e.g., two different television programs) at the same time by adopting the “split screen” technology or the “picture-in-picture (PiP)” technology. The “split screen” technology allows simultaneous, side by side, presentation of multiple sets of images respectively corresponding to multiple different sources by splitting a full-screen display into multiple smaller display areas. The “picture-in-picture” technology allows simultaneous presentation of multiple sets of images respectively corresponding to multiple different sources by superimposing at least one inset display window onto a full-screen display. However, both Of the “split screen” technology and the “picture-in-picture” technology have the downside that the quality (e.g., size) of the displayed images is degraded, and that the displayed images from one source inevitably create distractions to a certain extent for viewers watching the displayed images from another source. Therefore, there is the need to provide a display control method that permits different viewers to respectively and simultaneously watch different images using the same display screen without the aforesaid drawbacks.

### SUMMARY OF THE INVENTION

Therefore, an object of the present invention is to provide a display control method for supporting the display of a dual-source image on a single display panel for different viewers to watch while preventing information from the different sources from interfering with each other and creating distractions to an unintended viewer.

According to one aspect of the present invention, there is provided a display control method to be executed by a driver device. The driver device enables image display on a display panel via a plurality of data lines and a plurality of scan lines which cooperatively define a plurality of pixel units. The display panel is provided with two kinds of polarizing films of two different polarization directions that are orthogonal to each other at positions corresponding to the pixels units.

The display control method includes the steps of:

(A) converting a first data signal into a first image signal;

(B) converting a second data signal into a second image signal; and

(C) under control of a clock signal and according to arrangement of the two kinds of polarizing films, outputting the first image signal to the pixel units corresponding to which the display panel is provided with a first one of the two kinds of polarizing films, and outputting the second image signal to the pixel units corresponding to which the display panel is provided with a second one of the two kinds of the polarizing films, so as to generate an image frame on the display panel that corresponds to the first image signal and the second image signal.

Another object of the present invention is to provide a display apparatus that supports the display of a dual-source image that can overcome the aforesaid drawbacks of the prior art.

According to another aspect of the present invention, there is provided a display apparatus that includes a display panel, a plurality of data liens, a plurality of scan lines, and a driver device. The display panel is provided with two kinds of polarizing films of two different polarization directions that are orthogonal to each other. The scan lines cooperatively define a plurality of pixel units with the data lines. The driver device includes a first control module, a first driving module, a second control module, a second driving module, a scan module, and a clock module.

The first control module is adapted for receiving a first data signal, and performs processing on the first data signal so as to obtain a first image signal and a first control signal. The first driving module is coupled electrically to the first control module for receiving the first image signal therefrom, and is further coupled electrically to the data lines for transmitting the first image signal thus received to the pixel units via the data lines. The second control module is adapted for receiving a second data signal, and performs processing on the second data signal so as to obtain a second image signal and a second control signal. The second driving module is coupled electrically to the second control module for receiving the second image signal therefrom, and is further coupled electrically to the data lines for transmitting the second image signal thus received to the pixel units via the data lines. The scan module is coupled electrically to the first and second control modules for receiving the first and second control signals respectively therefrom, generates a scan signal with reference to the first and second control signals, and is further coupled electrically to the scan lines for transmitting the scan signal to the scan lines. The scan signal controls on/off states of the pixel units. The clock module is coupled electrically to the first and second driving modules for providing a clock signal thereto.

The first and second driving modules transmit the first and second image signals to the pixel units via the data lines under control of the clock signal provided by the clock module and according to arrangement of the two kinds of polarizing films, where the first image signal is transmitted to the pixel units corresponding to which the display panel is provided with a first one of the two kinds of polarizing films, and the second image signal is transmitted to the pixel units corresponding to which the display panel is provided with a second one of the two kinds of polarizing films, such that an image frame is generated on the display panel that corresponds to the first image signal and the second image signal.

Furthermore, the display apparatus may be used with a first pair of polarized glasses having a polarization corresponding to the first one of the two kinds of the polarizing films, and a second pair of polarized glasses having a polarization corresponding to the second one of the two kinds of the polarizing films. As such, a user wearing the first pair of polarized glasses can view the image composed by the first image signal, and a user wearing the second pair of polarized glasses can view the image composed by the second image signal. Accordingly, different users may view different images on the same display apparatus at the same time without having to reduce the size of the displayed area of any of the different images (unlike the “split screen” technology or the “picture-in-picture (PiP)” technology), and without the different images interfering with each other and creating distractions to an unintended viewer.

Preferably, the polarizing films of the first kind are horizontal polarizing films, and the polarizing films of the second kind are vertical polarizing films.

The advantage of the present invention lies in that the display of a dual-source image on a single display panel is permitted to enable different viewers to watch information composed by different sources, while preventing the information from the different sources from interfering with each other and creating distractions to an unintended viewer.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram, illustrating the preferred embodiment of a display apparatus according to the present invention;

FIG. 2 is a schematic diagram, illustrating the provision of horizontal polarizing films and vertical polarizing films on a display panel of the display apparatus;

FIG. 3 is a schematic block diagram, illustrating a driver device of the display apparatus;

FIG. 4 is a block diagram, illustrating a first driving module and a second driving module of the driver device;

FIG. 5 is a flow chart, illustrating a display control method according to the preferred embodiment of the present invention; and

FIG. 6 is a schematic diagram, illustrating an alternative arrangement of pixel units of the display apparatus.

### DETAILED DESCRIPTION OF THE PREFERRED EMBODIMENT

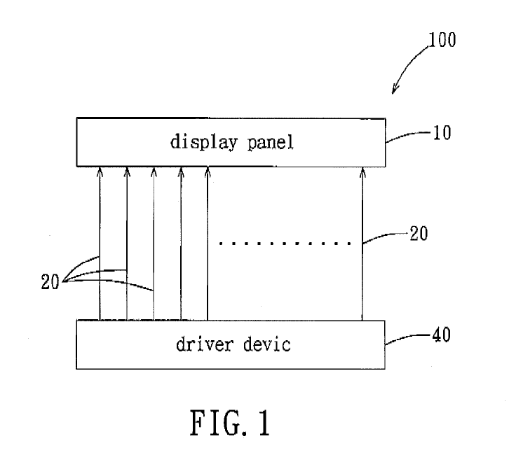

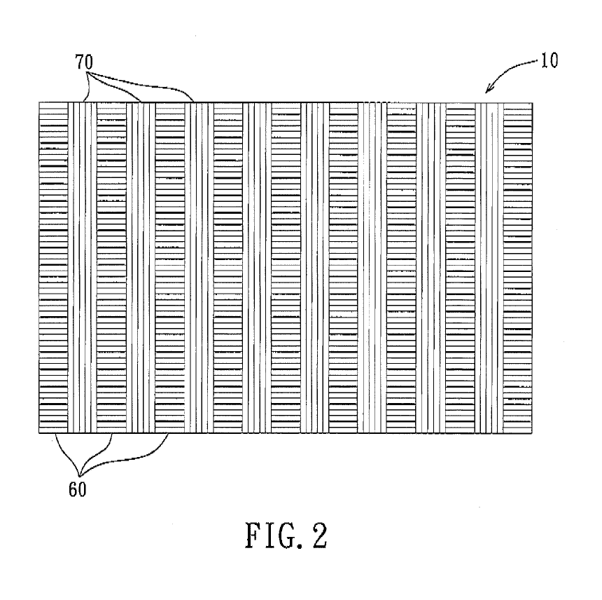

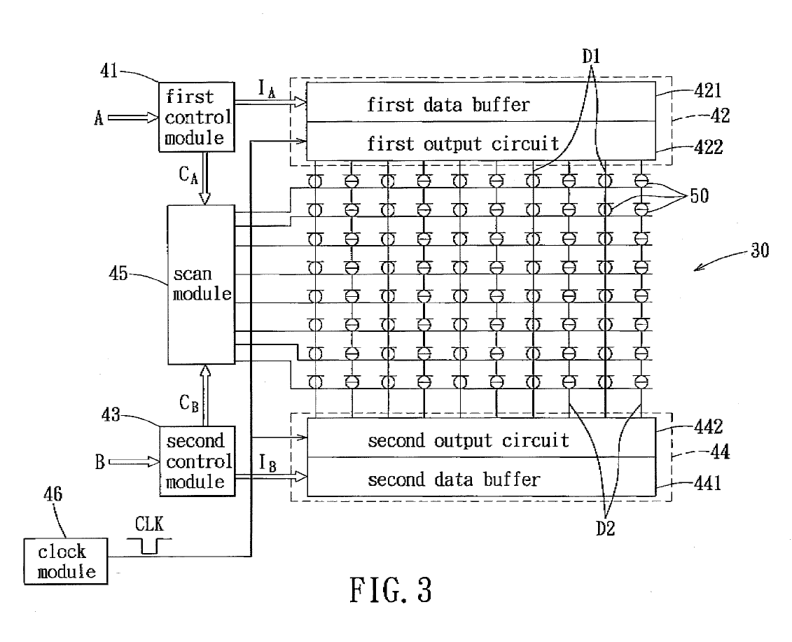

With reference to FIG. 1, FIG. 2 and FIG. 3, the preferred embodiment of a display apparatus 100 that supports display of a dual-source image according to the present invention is shown to include a display panel 10, a plurality of data lines 20, a plurality of scan lines 30 intersecting the data lines 20, and a driver device 40. The data lines 20 and the scan lines 30 cooperatively define a plurality of pixel units 50.

The display panel 10 is provided with two kinds of polarizing films 60, 70 of two different polarization directions. The polarizing films of the first kind 60 extend along an a direction, and the polarizing films of the second kind 70 extend along a β direction. In this embodiment, the α direction and the β direction are orthogonal to each other. Further, the polarizing films of the first kind 60 are provided on the display panel 10 at positions corresponding to the pixel units 50 that correspond to a first group of the data lines 20, and the polarizing films of the second kind 70 are provided on the display panel 10 at positions corresponding to the pixel units 50 that correspond to a second group of the data lines 20. The data lines 20 in the first and second groups are alternatingly arranged. In this embodiment, the polarizing films of the first kind 60 are horizontal polarizing films 60 and are provided on the display panel 10 at locations corresponding to odd ones of the data lines 20, while the polarizing films of the second kind 70 are vertical polarizing films 70 and are provided on the display panel 10 at locations corresponding to even ones of the data lines 20.

The driver device 40 includes a first control module 41, a first driving module 42, a second control module 43, a second driving module 44, a scan module 45 and a clock module 46. The first control module 41 is adapted for receiving a first data signal (A), and performs processing on the first data signal (A) so as to obtain a first image signal (I_{A}) and a first control signal (C_{A}). The first driving module 42 is coupled electrically to the first control module 41 for receiving the first image signal (I_{A}) therefrom, and is further coupled electrically to first terminals of the data lines 20 for transmitting the first image signal (I_{A}) thus received to the pixel units 50 via the data lines 20. The second control module 43 is adapted for receiving a second data signal (B), and performs processing on the second data signal (B) so as to obtain a second image signal (I_{B}) and a second control signal (C_{B}). The second driving module 44 is coupled electrically to the second control module 43 for receiving the second image signal (I_{B}) therefrom, and is further coupled electrically to second terminals of the data lines 20 for transmitting the second image signal (I_{B}) thus received to the pixel units 50 via the data lines 20. Herein, the first data signal (A) and the second data signal (B) may be transmitted from electronic devices such as television sets and game consoles, or may be provided over a network.

The scan module 45 is coupled electrically to the first and second control modules 41, 42 for receiving the first and second control signals (C_{A}, C_{B}) respectively therefrom, and generates a scan signal with reference to the first and second control signals (C_{A}, C_{B}). The scan module 45 is further coupled electrically to the scan lines 30 for transmitting the scan signal to the scan lines 30. The scan signal controls on/off states of the pixel units 50. The clock module 46 is coupled electrically to the first and second driving modules 42, 44 for feeding a periodic clock signal (CLK) thereto so as to drive the first and second driving modules 42, 44 to transmit the first and second image signals (I_{A}, I_{B}) to the pixel units 50 via the data lines 20. That is to say, the first and second driving modules 42, 44 transmit the first and second image signals (I_{A}, I_{B}) to the pixel units 50 via the data lines 20 under control of the clock signal (CLK) as provided by the clock module 46. In this embodiment, the first and second image signals (I_{A}, I_{B}) are transmitted to the pixel units 50 according to the arrangement of the two kinds of polarizing films 60, 70, where the first image signal (I_{A}) is transmitted to the pixel units 50 corresponding to which the display panel 10 is provided with the polarizing films of the first kind 60, and the second image signal (I_{B}) is transmitted to the pixel units 50 corresponding to which the display panel 10 is provided with the polarizing films of the second kind 70. As such, an image frame is generated on the display panel 10 that corresponds to the first image signal (I_{A}) and the second image signal (I_{B}).

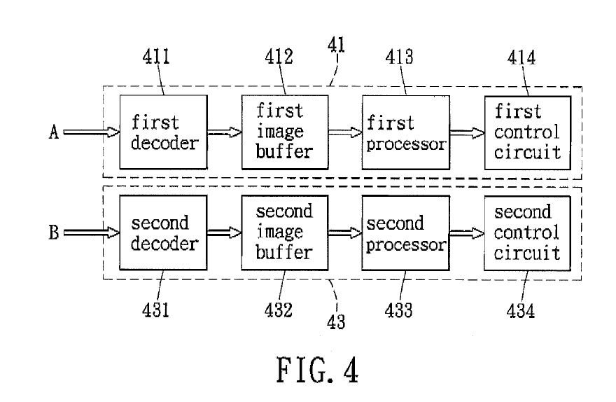

Referring to FIG. 3 and FIG. 4, the first control module 41 includes a first decoder 411, a first image buffer 412, a first processor 413 and a first control circuit 414. The first decoder 411 is adapted for decoding the first data signal (A) so as to obtain a first digital signal (D_{A}). The first image buffer 412 is coupled electrically to the first decoder 411 for storing the first digital signal (D_{A}). The first processor 413 is a digital signal processor (DSP), is coupled electrically to the first image buffer 412 for retrieving the first digital signal (D_{A}) therefrom, and converts the first digital signal (D_{A}) into the first image signal (I_{A}) and the first control signal (C_{A}). The first control circuit 414 is coupled electrically to the first processor 413 for receiving the first image signal (I_{A}) and the first control signal (C_{A}) therefrom, and is further coupled electrically to the first driving module 42 and the scan module 45 for transmitting the first image signal (I_{A}) and the first control signal (C_{A}) respectively thereto.

The second control module 43 includes a second decoder 431, a second image buffer 432, a second processor 433 and a second control circuit 434. The second decoder 431 is adapted for decoding the second data signal (B) so as to obtain a second digital signal (D_{B}). The second image buffer 432 is coupled electrically to the second decoder 431 for storing the second digital signal (D_{B}). The second processor 433 is a digital signal processor (DSP), is coupled electrically to the second image buffer 432 for retrieving the second digital signal (D_{B}) therefrom, and converts the second digital signal (D_{B}) into the second image signal (I_{B}) and the second control signal (C_{B}). The second control circuit 434 is coupled electrically to the second processor 433 for receiving the second image signal (I_{A}) and the second control signal (C_{B}) therefrom, and is further coupled electrically to the second driving module 44 and the scan module 45 for transmitting the second image signal (I_{B}) and the second control signal (C_{B}) respectively thereto.

The first driving module 42 includes a first data buffer 421 and a first output circuit 422. The first data buffer 421 is coupled electrically to the first control circuit 414 of the first control module 41 for storing the first image signal (I_{A}) received therefrom. The first output circuit 422 is coupled electrically to the first data buffer 421 for transmitting the first image signal (I_{A}) to the pixel units 50 via the data lines 20 under control of the clock signal (CLK).

The second driving module 44 includes a second data buffer 441 and a second output circuit 442. The second data buffer 441 is coupled electrically to the second control circuit 434 of the second control module 43 for storing the second image signal (I_{B}) received therefrom. The second output circuit 942 is coupled electrically to the second data buffer 441 for transmitting the second image signal (I_{B}) to the pixel units 50 via the data lines 20 under control of the clock signal (CLK).

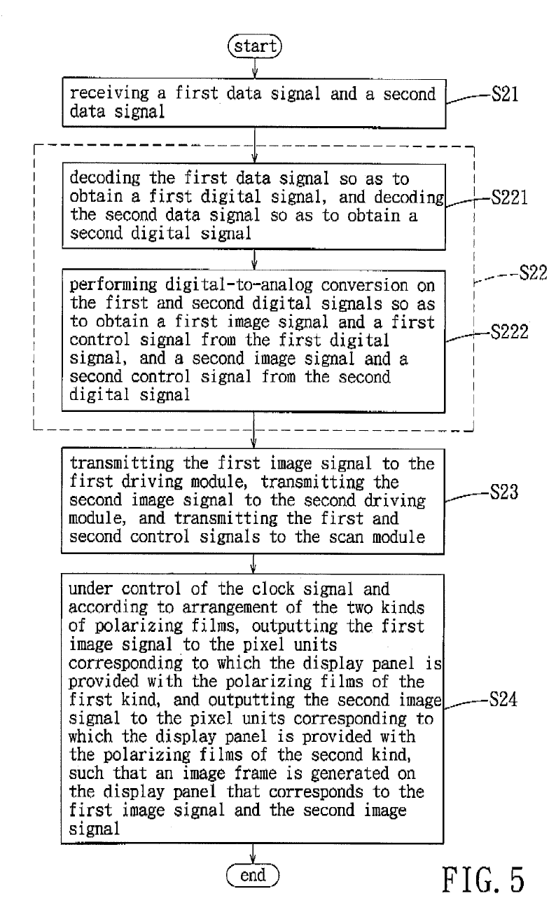

Referring to FIG. 3, FIG. 4 and FIG. 5, a display control method for controlling display of a dual-source image on the display apparatus 100 includes the following steps.

In step S21, a first data signal (A) and a second data signal (B) are received by the first control module 41 and the second control module 42, respectively.

In step S22, the first data signal (A) is converted into a first image signal (I_{A}) and the second data signal (B) is converted into a second image signal (I_{B}).

In this embodiment, from the first data signal (A), a first control signal (C_{A}) is further obtained in addition to the first image signal (I_{A}), and from the second data signal (S), a second control signal (C_{B}) is further obtained in addition to the second image signal (I_{B}). Specifically, step S22 includes the following sub-steps.

In sub-step S221, the first data signal (A) is decoded by the first decoder 411 so as to obtain a first digital signal (D_{A}), and the second data signal (B) is decoded by the second decoder 431 so as to obtain a second digital signal (D_{B}). The first and second digital signals (D_{A}, D_{B}) are stored respectively in the first and second image buffers 412, 432.

In sub-step S222, the first and second digital signals (D_{A}, D_{B}) are retrieved from the first and second image buffers 412, 432 by the first and second processors 413, 433, respectively, for performing digital-to-analog conversions on the first and second digital signals (D_{A}, D_{B}) so as to obtain the first image signal (I_{A}) and the first control signal (C_{A}) from the first digital signal (D_{A}), and the second image signal (I_{B}) and the second control signal (C_{B}) from the second digital signal (D_{B}). The first image signal (I_{A}) and the first control signal (C_{A}) are transmitted to the first control circuit 414, and the second image signal (I_{B}) and the second control signal (C_{B}) are transmitted to the second control circuit 434.

Subsequently, in step S23, the first image signal (I_{A}) is transmitted by the first control circuit 414 to the first driving module 42, the second image signal (I_{B}) is transmitted by the second control circuit 434 to the second driving module 44, the first control signal (C_{A}) is transmitted by the first control circuit 414 to the scan module 45, and the second control signal (C_{B}) is transmitted by the second control circuit 434 to the scan module 45.

In step S24, under control of the clock signal (CLK) and according to arrangement of the two kinds of polarizing films 60, 70, the first image signal (I_{A}) is outputted by the first driving module 42 to the pixel units 50 corresponding to which the display panel 10 is provided with the polarizing films of the first kind 60, and the second image signal (I_{B}) is outputted by the second driving module 44 to the pixel units 50 corresponding to which the display panel 10 is provided with the polarizing films of the second kind 70, such that an image frame is generated on the display panel 10 that corresponds to the first image signal (I_{A}) and the second image signal (I_{B}).

In other words, the pixel units 50 of the display apparatus 100 according to this embodiment are grouped into two groups, namely a first group (D1) and a second group (D2). The pixel units 50 in the first group (D1) are represented by Φ in FIG. 3, and the pixel units 50 in the second group (D2) are represented by θ in FIG. 3. The pixel units 50 in the first group (D1) are located on the odd ones of the data lines 20 and correspond to the polarizing films of the first kind 60, and the pixel units 50 in the second group (D2) are located on the even ones of the data lines 20 and correspond to the polarizing films of the second kind 70. Therefore, under control of the clock signal (CLK) and according to the scan signal generated by the scan module 45, the first image signal (I_{A}) is outputted by the first driving module 42 to the pixel units 50 in the first group (D1), and the second image signal (I_{B}) is outputted by the second driving module 44 to the pixel units 50 in the second group (D2). As a result, the pixel units 50 in the first and second groups (D1, D2) are simultaneously driven to present the first and second image signals (I_{A}, I_{B}), respectively, such that the image frame displayed on the display panel 10 at one time is a dual-source image frame that contains information from both the first and second image signals (I_{A}, I_{D}). The presentation of the first and second image signals may be in an alternating manner.

In this embodiment, while not shown in the drawings, the display apparatus 100 may be used with a pair of horizontally polarized glasses corresponding to the horizontal polarizing films 60 (the first kind) and a pair of vertically polarized glasses corresponding to the vertical polarizing films 70 (the second kind) in a display system (not shown). While wearing the horizontally polarized glasses, a user can view the image composed by the pixel units 50 in the first group (D1) (i.e., the image corresponding to the first image signal (I_{A})). While wearing the vertically polarized glasses, a user can view the image composed by the pixel units 50 in the second group (D2) (i.e., the image corresponding to the second image signal (I_{B})). Accordingly, different users wearing different glasses may view different images simultaneously displayed on the full-screen of the same display apparatus 100 at the same time without the size of the displayed area reduced (unlike the “split screen” technology or the “picture-in-picture (PiP)” technology), and without the image corresponding to the first image signal (I_{A}) and the image corresponding to the second image signal (I_{B}) interfering with each other.

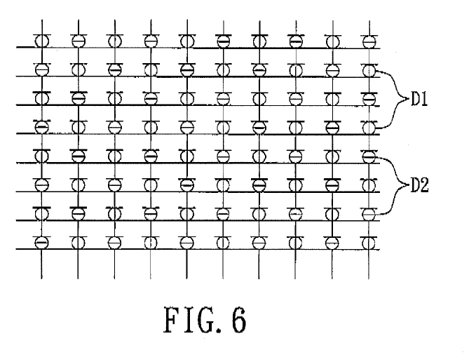

It should be noted herein that the pixel units 50 in the first and second groups (D1, D2) can be arranged in rows or columns, while rows (or columns) of the first and second groups (D1, D2) are alternatingly arranged, as shown in FIG. 3. Alternatively, the pixel units 50 in the first and second groups (D1, D2) may be arranged such that adjacent ones of the pixel units 50 belong to different groups, as illustrated in FIG. 6. The present invention is operable as long as the corresponding relationship between the pixel units 50 of the first group (D1) and the polarizing films of the first kind 60, and the corresponding relationship between the pixel units 50 of the second group (D2) and the polarizing films of the second kind 70 remain. It should be further noted herein that it is not necessary for the polarizing films of the first and second kinds 50, 70 to be horizontal and vertical polarizing films, as illustrated herein in this embodiment, as long as the polarization directions of the polarizing films of the two kinds are orthogonal to each other. A person skilled in the art should readily appreciate that the glasses worn by the viewers need to be polarized in the corresponding directions.

In summary, under control of the clock signal (CLK) generated by the clock module 46, the first and second driving modules 42, 44 transmit simultaneously the first and second image signals (I_{A}, I_{B}) to the pixel units 50 via the data lines 20, respectively, such that a dual-source image frame is generated cooperatively by the pixel units 50 and displayed on the same display panel 10 for viewing by different viewers at the same time without diminishing the size of the displayed images, and without creating distractions and interferences to the viewers intended at watching images from a different source. In other words, through the display control method that supports display of a dual-source image frame according to the present invention, a single display apparatus 100 according to the present invention embodies what can only be achieved by two separate display apparatuses, thereby enhancing the utility and value of the display apparatus 100, and reducing the cost for accommodating the display of two sources.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display control method to be executed by a driver device, the driver device enabling image display on a display panel via a plurality of data lines and a plurality of scan lines which cooperatively define a plurality of pixel units, the display panel being provided with two kinds of polarizing films of two different polarization directions that are orthogonal to each other at positions corresponding to the pixels units, said display control method comprising the steps of:
(A) converting a first data signal into a first image signal;
(B) converting a second data signal into a second image signal; and
(C) under control of a clock signal and according to arrangement of the two kinds of polarizing films, outputting the first image signal to the pixel units corresponding to which the display panel is provided with a first one of the two kinds of polarizing films, and outputting the second image signal to the pixel units corresponding to which the display panel is provided with a second one of the two kinds of polarizing films, so as to generate an image frame on the display panel that corresponds to the first image signal and the second image signal.

2. The display control method as claimed in claim 1, the first one of the two kinds of polarizing films of the first kind being provided on the display panel at positions corresponding to the pixel units that correspond to a first group of the data lines, the second one of the two kinds of polarizing films being provided on the display panel at positions corresponding to the pixel units that correspond to a second group of the data lines, the data lines in the first and second groups being alternatingly arranged, wherein in step (C), the first image signal is outputted to the pixel units that correspond to the first group of the data lines and the second image signal is outputted to the pixel units that correspond to the second group of the data lines.

3. The display control method as claimed in claim 1, wherein:
step (A) includes the sub-steps of
(A-1) decoding the first data signal so as to obtain a first digital signal, and
(A-2) performing digital-to-analog conversion on the first digital signal so as to obtain the first image signal; and
step (B) includes the sub-steps of
(B-1) decoding the second data signal so as to obtain a second digital signal, and
(B-2) performing digital-to-analog conversion on the second digital signal so as to obtain the second image signal.

4. A display apparatus, comprising:
a display panel provided with two kinds of polarizing films of two different polarization directions that are orthogonal to each other;
a plurality of data lines;
a plurality of scan lines cooperatively defining a plurality of pixel units with said data lines; and
a driver device including
a first control module adapted for receiving a first data signal, and performing processing on the first data signal so as to obtain a first image signal and a first control signal,
a first driving module coupled electrically to said first control module for receiving the first image signal therefrom, and further coupled electrically to said data lines for transmitting the first image signal thus received to said pixel units via said data lines;
a second control module adapted for receiving a second data signal, and performing processing on the second data signal so as to obtain a second image signal and a second control signal,
a second driving module coupled electrically to said second control module for receiving the second image signal therefrom, and further coupled electrically to said data lines for transmitting the second image signal thus received to said pixel units via said data lines,
a scan module coupled electrically to said first and second control modules for receiving the first and second control signals respectively therefrom, generating a scan signal with reference to the first and second control signals, and further coupled electrically to said scan lines for transmitting the scan signal to said scan lines, the scan signal controlling on/off states of said pixel units, and
a clock module coupled electrically to said first and second driving modules for providing a clock signal thereto,
wherein said first and second driving modules transmit the first and second image signals to said pixel units via said data lines under control of the clock signal provided by said clock module and according to arrangement of the two kinds of polarizing films, in which the first image signal is transmitted to said pixel units corresponding to which said display panel is provided with a first one of the two kinds of polarizing films, and the second image signal is transmitted to said pixel units corresponding to which said display panel is provided with a second one of the two kinds of polarizing films, such that an image frame is generated on said display panel that corresponds to the first image signal and the second image signal.

5. The display apparatus as claimed in claim 4, wherein said first control module includes:
a first decoder adapted for decoding the first data signal so as to obtain a first digital signal;
a first image buffer coupled electrically to said first decoder for storing the first digital signal;
a first processor coupled electrically to said first image buffer for obtaining the first digital signal therefrom, and converting the first digital signal into the first image signal and the first control signal; and
a first control circuit coupled electrically to said first processor for receiving the first image signal and the first control signal therefrom, further coupled electrically to said first driving module for transmitting the first image signal thereto, and further coupled electrically to said scan module for transmitting the first control signal thereto.

6. The display apparatus as claimed in claim 4, wherein said second control module includes:
a second decoder adapted for decoding the second data signal so as to obtain a second digital signal;
a second image buffer coupled electrically to said second decoder for storing the second digital signal;
a second processor coupled electrically to said second image buffer for obtaining the second digital signal therefrom, and converting the second digital signal into the second image signal and the second control signal; and
a second control circuit coupled electrically to said second processor for receiving the second image signal and the second control signal therefrom, further coupled electrically to said second driving module for transmitting the second image signal thereto, and further coupled electrically to said scan module for transmitting the second control signal thereto.

7. The display apparatus as claimed in claim 4, wherein the first one of the two kinds of polarizing films is provided on said display panel at positions corresponding to said pixel units that correspond to a first group of said data lines, and the second one of the two kinds of polarizing films is provided on said display panel at positions corresponding to said pixel units that correspond to a second group of said data lines, said data lines in said first and second groups being alternatingly arranged.

8. The display apparatus as claimed in claim 7, wherein the first one of the two kinds of polarizing films is a horizontal polarizing film, and the second one of the two kinds of polarizing films is a vertical polarizing film.

9. A display system, comprising:
a display apparatus that includes
a display panel provided with two kinds of polarizing films of two different polarization directions that are orthogonal to each other;
a plurality of data lines;
a plurality of scan lines cooperatively defining a plurality of pixel units with said data lines; and
a driver device including
a first control module adapted for receiving a first data signal, and performing processing on the first data signal so as to obtain a first image signal and a first control signal,
a first driving module coupled electrically to said first control module for receiving the first image signal therefrom, and further coupled electrically to said data lines for transmitting the first image signal thus received to said pixel units via said data lines;
a second control module adapted for receiving a second data signal, and performing processing on the second data signal so as to obtain a second image signal and a second control signal,
a second driving module coupled electrically to said second control module for receiving the second image signal therefrom, and further coupled electrically to said data lines for transmitting the second image signal thus received to said pixel units via said data lines,
a scan module coupled electrically to said first and second control modules for receiving the first and second control signals respectively therefrom, generating a scan signal with reference to the first and second control signals, and further coupled electrically to said scan lines for transmitting the scan signal to said scan lines, the scan signal controlling on/off states of said pixel units, and a clock module coupled electrically to said first and second driving modules for providing a clock signal thereto,
wherein said first and second driving modules transmit the first and second image signals to said pixel units via said data lines under control of the clock signal provided by said clock module and according to arrangement of the two kinds of polarizing films, in which the first image signal is transmitted to said pixel units corresponding to which said display panel is provided with a first one of the two kinds of polarizing films, and the second image signal is transmitted to said pixel units corresponding to which said display panel is provided with a second one of the two kinds of polarizing films, such that an image frame is generated on said display panel that corresponds to the first image signal and the second image signal;
a first pair of polarized glasses having a polarization corresponding to the first one of the two kinds of polarizing films; and
a second pair of polarized glasses having a polarization corresponding to the second one of the two kinds of polarizing films.
